(19) United States
(12) Patent Application Publication
(10) Pub. No.: US 2026/0370274 A1
(43) Pub. Date: Nov. 19, 2026

(54) SPATIALLY COUPLED CODE BLOCK MAPPING FOR PRECODING GROUPS

(71) Applicant: QUALCOMM Incorporated, San Diego, CA (US)

(72) Inventors: Chih-Hao LIU, San Diego, CA (US); Jing SUN, San Diego, CA (US); Yu ZHANG, San Diego, CA (US); Tzu-Hsuan CHOU, San Diego, CA (US)

(21) Appl. No.: 19/211,057

(22) Filed: May 16, 2025

(51) Int. Cl. H04B 7/0456; H04L 5/00

(52) U.S. Cl. CPC H04B 7/0456; H04L 5/0014

(57) ABSTRACT

This disclosure provides systems, methods and apparatuses for communication using spatially coupled code blocks for precoding groups. A receiving device is configured to: receive a first part of the code block on a first layer of a first precoding group; receive a second part of the code block on a second layer of a second precoding group, the second layer spatially coupled with the first layer of the first precoding group; demap the first part in a first demapper and demap the second part in a second demapper; and decode the code block based on the first part and the second part.

### TECHNICAL FIELD

The present disclosure relates to wireless communications including spatially coupled code block (CB) mapping for precoding groups.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to an apparatus for wireless communication, including: one or more memories; and one or more processors coupled with one or more memories and configured, individually or in combination, to: receive a first part of the code block on a first layer of a first precoding group; receive a second part of the code block on a second layer of a second precoding group, the second layer spatially coupled with the first layer of the first precoding group; demap the first part in a first demapper and demap the second part in a second demapper; and decode the code block based on the first part and the second part.

In some aspects, the techniques described herein relate to a method of receiving a code block, including: receiving a first part of the code block on a first layer of a first precoding group; receiving a second part of the code block on a second layer of a second precoding group, the second layer spatially coupled with the first layer of the first precoding group; demapping the first part in a first demapper and demapping the second part in a second demapper; and decoding the code block based on the first part and the second part.

In some aspects, the techniques described herein relate to an apparatus for receiving a code block, including: means for receiving a first part of the code block on a first layer of a first precoding group and receiving a second part of the code block on a second layer of a second precoding group, the second layer spatially coupled with the first layer of the first precoding group; means for demapping the first part in a first demapper and demapping the second part in a second demapper; and means for decoding the code block based on the first part and the second part.

In some aspects, the techniques described herein relate to an apparatus for wireless communication, including: one or more memories; and one or more processors coupled with one or more memories and configured, individually or in combination, to: split a code block into a number of parts corresponding to a number of precoding groups; map each part of the code block to a spatially coupled layer within a respective precoding group; and transmit the code block across the mapped layers via different precoders for the precoding groups.

In some aspects, the techniques described herein relate to a method of receiving a code block, including: splitting a code block into a number of parts corresponding to a number of precoding groups; mapping each part of the code block to a spatially coupled layer within a respective precoding group; and transmitting the code block across the mapped layers via different precoders for the precoding groups.

In some aspects, the techniques described herein relate to an apparatus for receiving a code block, including: means for splitting a code block into a number of parts corresponding to a number of precoding groups; means for mapping each part of the code block to a spatially coupled layer within a respective precoding group; and means for transmitting the code block across the mapped layers via different precoders for the precoding groups.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram of an example receiver including a demapper.

FIG. 6 is a diagram illustrating an example of spatially coupled multiple-input multiple-output (MIMO) layer mapping with successive interference cancellation (SIC).

FIG. 7 is a diagram of an example receiver with multiple demappers.

FIG. 8 is a diagram of a first example code block spatial coupling scheme with a single codeword.

FIG. 9 is a diagram of a second example code block spatial coupling scheme with a multiple codewords.

FIG. 10 is a diagram of a third example code block spatial coupling scheme with staggered code blocks.

FIG. 11 is a diagram of a fourth example code block spatial coupling scheme with additional precoding groups.

FIG. 12 is a message diagram illustrating messages for configuration of transmissions with spatial coupling of precoding groups.

FIG. 13 is a conceptual data flow diagram illustrating the data flow between different means/components in an example network entity including a spatial coupling transmit (Tx) component.

FIG. 14 is a conceptual data flow diagram illustrating the data flow between different means/components in an example UE including a spatial coupling receive (Rx) component.

FIG. 15 is a flowchart of an example method for a wireless node such as a UE to receive a transmission with spatial coupling of precoding groups.

FIG. 16 is a flowchart of an example method for a wireless node such as a network entity to transmit data with spatial coupling of precoding groups.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, 6G, or further implementations thereof, technology.

In wireless communications, multiple-input multiple-output (MIMO) schemes utilize multiple antennas to improve transmission properties. For example, multiple spatial streams may be transmitted to increase throughput. As another example, precoding may be used to improve channel quality. An example of an advanced precoding technique is a geometric mean decomposition (GMD) precoder. A GMD transceiver transforms the system into M independent scalar Gaussian channels with the same signal to interference plus noise ratio (SINR). A GMD precoder can achieve significant gains over a single variable decomposition (SVD) precoder in a high signal to noise ratio (SNR) region because it rebalances the per layer SNR. A decision feedback equalizer (DFE) receiver may be used to demap signals transmitted from the GMD transceiver into code blocks for individual channels.

One issue with a GMD/DFE system is that a DFE receiver is known to suffer from error propagation. A conventional DFE demapper involves hard slicing the received log likelihood ratios (LLRs) to reconstruct the quadrature amplitude modulation (QAM) symbol from higher layer(s) and successively cancel the interference in the target lower layer. Accordingly, errors in the higher layer(s) can propagate into the lower layer. To reduce the cross layer error propagation, it would be desirable to allow channel coding to correct the bit error and reconstruct the QAM symbol from the higher layer(s) without propagating the bit error to the lower layer.

In an aspect, the present disclosure provides for spatial coupling of code blocks across precoder groups such as GMD groups. By spatially coupling code blocks transmitted via different precoders, the receiver can benefit from spatial diversity for a code block that spans multiple precoder groups. Within each group of layers for the precoder group, per layer code block detection, re-encoding, and successive interference cancelation (SIC) can help the error propagation in the DFE demapper. For example, a receiver may receive a first part of a code block on a first layer of a precoding group and receive a second part of the code block on a second layer of a second precoding group. The first layer can be spatially coupled with the second layer. The first part of the code block and the second part of the code block can be separately demapped (e.g., in parallel demappers). The code block can be decoded based on the first part and the second part.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

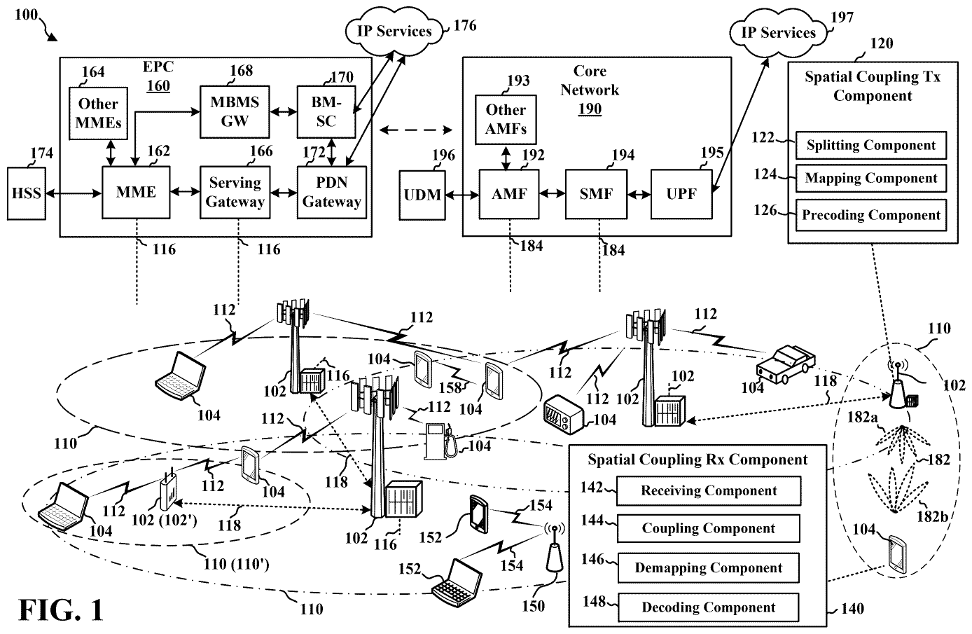

FIG. 1 is a diagram illustrating an example of a wireless communications system and an access network 100. The wireless communications system (also referred to as a wireless wide area network (WWAN)) includes wireless nodes such as base stations 102 and UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as one or more central units (CUs) 188, one or more distributed units (DUs) 186, or a radio unit (RU) 180. Such architectures may be configured to utilize a protocol stack that is logically split between one or more units (such as one or more CUs and one or more DUs). In some aspects, the CUS 188 may be implemented within an edge RAN node, and in some aspects, one or more DUs 186 may be co-located with a CU 188, or may be geographically distributed throughout one or multiple RAN nodes. The DUs 186 may be implemented to communicate with one or more RUs 180.

In some implementations, one or more wireless nodes such as the UEs 104 include a spatial coupling Rx component 140 configured to receive a transmission with spatially coupled code blocks for precoding groups. The spatial coupling Rx component 140 includes a receiving component 142, a coupling component 144, a demapping component 146, and a decoding component 148. The receiving component 142 is configured to receive a first part of the code block on a first layer of a first precoding group and receive a second part of the code block on a second layer of a second precoding group. The coupling component 144 is configured to determine that the second layer is spatially coupled with the first layer of the first precoding group. The demapping component 146 is configured to demap the first part in a first demapper and demap the second part in a second demapper. The decoding component 148 is configured to decode the code block based on the first part and the second part.

In some implementations, one or more of wireless nodes such as the network entities including a base station 102 may include a spatial coupling Tx component 120. In particular, the spatial coupling Tx component 120 is configured to transmit a transmission with spatially coupled code blocks for precoding groups. The spatial coupling Tx component 120 includes a splitting component 122, a mapping component 124, and a precoding component 126. The splitting component 122 is configured to split a code block into a number of parts corresponding to a number of precoding groups. The mapping component 124 is configured to map each part of the code block to a spatially coupled layer within a respective precoding group. The precoding component 126 is configured to transmit the code block across the mapped layers via different precoders for the precoding groups.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 116 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 118 (such as X2 interface). The third backhaul links 118 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station may utilize beamforming 182 with the UE 104 to compensate for the path loss and short range. For example, the base station 102 may use beamforming 182 to transmit beams 182a and the UE 104 may utilize beamforming 182 to transmit beams 182b.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 6G, the concepts described herein may be applicable to other similar areas, such as 5G NR, LTE, LTE-A, CDMA, GSM, and other wireless technologies including future wireless technologies.

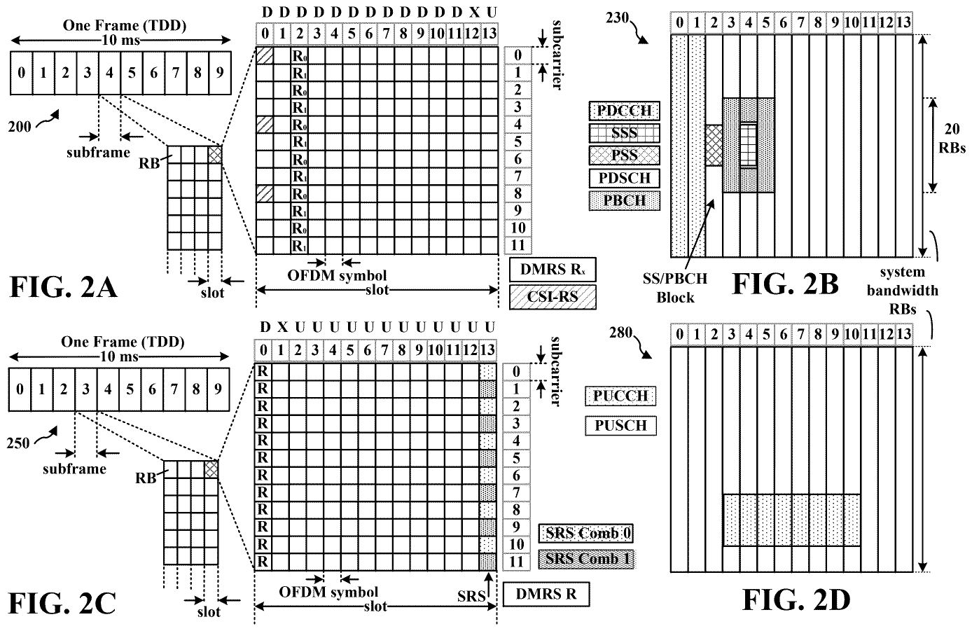

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DMRS) (indicated as Rx for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

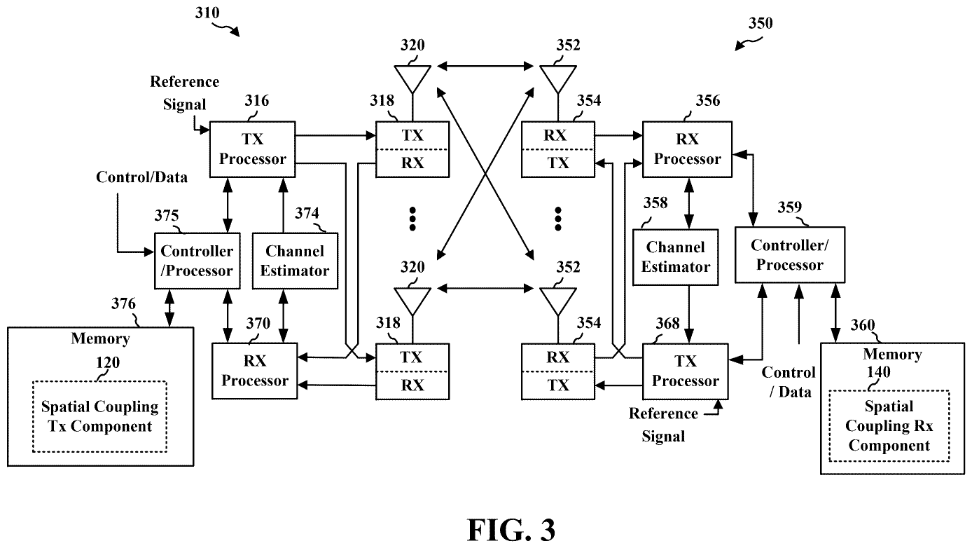

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission. In a split architecture, the transmitters/receivers 318 may be located in an RU 180, and the Tx processor 316, channel estimator 374, controller/processor 375, and Rx processor 370 may be located in a DU 186.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the spatial coupling Rx component 140 of FIG. 1. For example, the memory 360 may include executable instructions defining the spatial coupling Rx component 140. The TX processor 368, the RX processor 356, and/or the controller/processor 359 may be configured to execute the Spatial coupling Rx component 140.

At least one of the TX processor 316, the RX processor 370, and the controller/processor 375 may be configured to perform aspects in connection with the spatial coupling Tx component 120 of FIG. 1. For example, the memory 376 may include executable instructions defining the spatial coupling Tx component 120. The TX processor 316, the RX processor 370, and/or the controller/processor 375 may be configured to execute the spatial coupling Tx component 120.

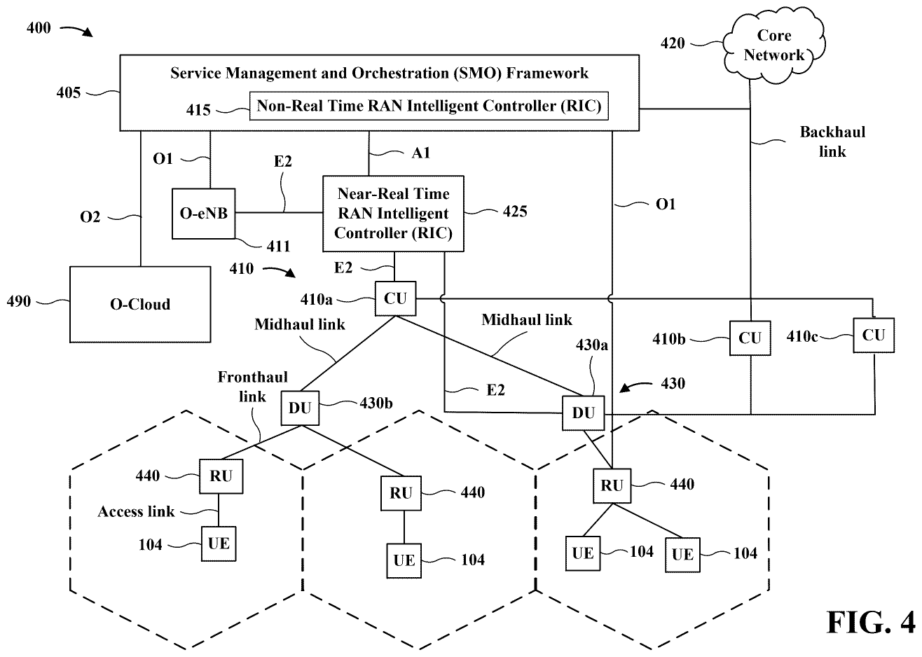

FIG. 4 is a diagram illustrating an example disaggregated base station 400 architecture. The disaggregated base station 400 architecture may include one or more central units (CUs) 410 (e.g., CU 410a, 410b, or 410c) that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 (e.g., DU 430a or 430b) via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

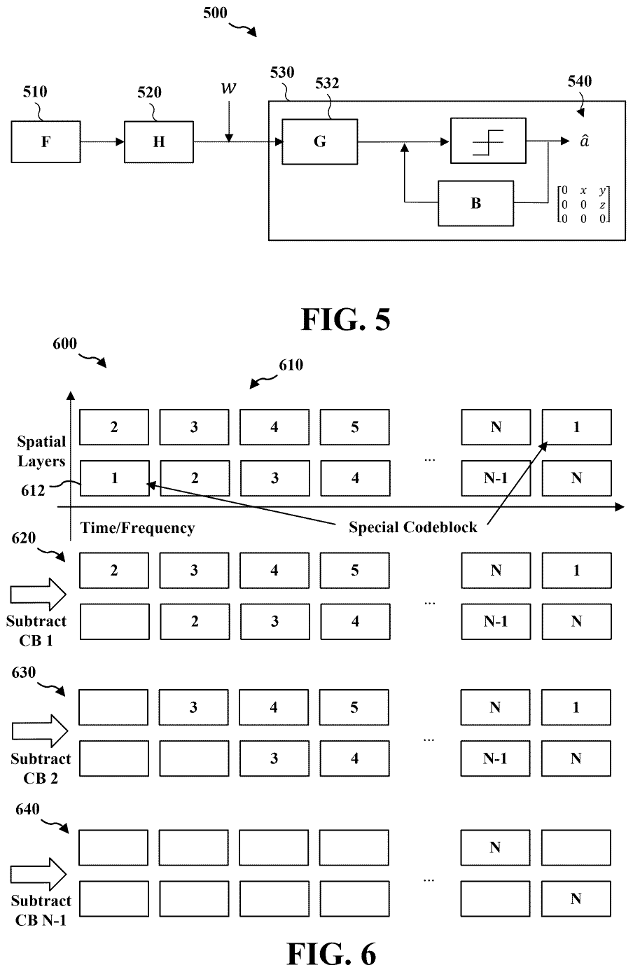

FIG. 5 is a diagram of an example receiver 500 including a demapper 530. The receiver 500 may be referred to as a decision feedback equalizer (DFE) receiver. The demapper 530 may be referred to as a DFE demapper or a vertical layered space-time demapper. In some implementations, the receiver 500 is part of a system including a precoder 510 (F). For instance, the precoder 510 may be a geometric mean decomposition (GMD) precoder. In some implementations, the precoder 510 is a generalized GMD precoder (GGMD).

The precoder 510 is based on a channel 520 H. The channel 520 may be represented by the following equation:

H=QRP^{H}=QD_{R}(I+B)P^{H},

where P and Q are semi-unitary matrices and R is an upper triangular matrix, and where

R=D_{R}(I+B),

where D_{R} is a diagonal matrix with Rᵢᵢ on its diagonal. The precoder 510 can be represented as F=P. A feed forward equalizer 532 G corresponding to the precoder 510 can be represented by the equation: G=D_{R}⁻¹ Q^{H}.

The precoder 510 may be applied after a single variable decomposition (SVD) precoder that diagonalizes the MIMO channels. The precoder 510 may equalize the SNR of the channels. In some cases, the generation of the precoder 510 may increase complexity at both the transmitter and receiver. For instance, when there are a large number of layers (e.g., 8 layers), calculating the precoder 510 may become more complex.

At the receiver 500, the demapper 530 may equalize the layers of the received signal in the precoding group at the feed forward equalizer 532. The symbols (â) 540 for one layer may be demapped, then iteratively removed from the signal based on B.

FIG. 6 is a diagram 600 illustrating an example of spatially coupled MIMO layer mapping with successive interference cancellation (SIC). Spatial coupling may separate a code block onto different spatial layers after encoding. In a single codeword design using irregular low density parity check (LDPC) code, a non-linear MIMO demodulator (e.g., a per stream recursive demodulator) can perform iterative demodulation and decoding across layers to achieve channel capacity. Spatial coupling can improve diversity. A single codeword rate can be selected to match the collective channel quality across multiple layers. The single codeword rate facilitates SIC across code blocks within the same transport block and codeword. Each code block codes across interference-free layers and full-interference layers.

As illustrated, the code blocks 610 can be split between spatial layers and staggered in time or frequency. A first code block 612 can be a special code block that is easier to decode (e.g., with a lower coding rate). Once the special code block is decoded in a first iteration, SIC can be used in a second iteration 620 to remove the special code block 612 and improve decoding of the other spatial layers (e.g., carrying code block 2) on the same time/frequency resources. Then, in a third iteration 630, code block 2 can be subtracted to improve decoding of the lower layer carrying code block 3. The process can continue until a final iteration 640, where only the final code block remains.

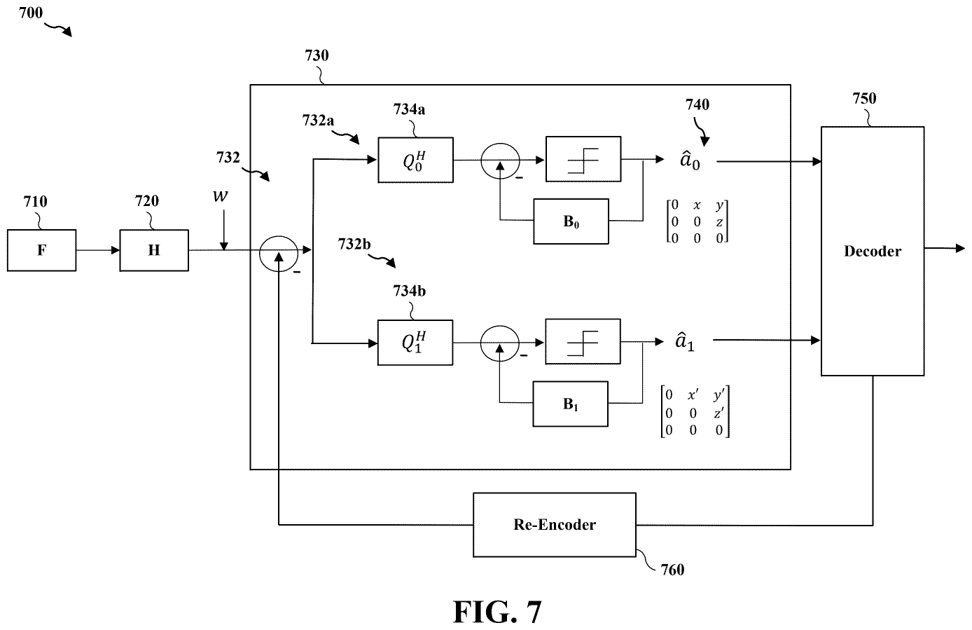

FIG. 7 is a diagram 700 of an example receiver 730 with multiple demappers 732. As discussed above regarding FIG. 5, GMD precoding can decompose a MIMO channel as a product of QRP^{H} such that the upper triangular matrix R is block diagonal. In an aspect, due to the complexity with a large number of layers, dividing the layers into precoding groups may be beneficial. The channel 720 may be represented according to the following equation:

$$H = [ {Q}_{0} {Q}_{1} ] [ \begin{matrix}{R}_{0} & 0 \\ 0 & {R}_{1}\end{matrix} ] [ \begin{matrix}{P}_{0}^{H} \\ {P}_{1}^{H}\end{matrix} ] ,$$

where Rᵢ=D_{R}_{ᵢ}(I+Bᵢ), D_{R}_{ᵢ} is a diagonal matrix with [Rᵢ]ᵢᵢ on its diagonal. Rᵢ has equal diagonal elements which equals to the geometric mean of SVD values of layers in the ith GMD group of layers. The precoder F=[P₀ P₁] where Pᵢ is the precoder for the ith group of layers. That is, the precoder F includes a precoder for each group of layers. Each GGMD group of layers has its own DFE demapper 732 (e.g., demapper 732a and 732b) with an equalizer 734 (e.g., equalizer 734a and 734b) derived from (Qᵢ, Bᵢ). Layers within each GGMD group have equal channel gain and SNR. Each DFE demapper 732 outputs LLRs 740 for the symbols of the code blocks.

Additionally, the receiver may include a decoder 750 that obtains the LLRs from the demappers 732. The decoder 750 decodes a code block based on the LLRs corresponding to symbols from spatially coupled layers. The decoder 750 can output a decoded code block as the received bits. The decoder 750 can also output the decoded code block to a re-encoder 760 that is configured to re-encode the decoded code block based on the precoders 710 and reconstruct a signal based on the re-encoded code block. The reconstructed signal can be subtracted from the received signal to improve the demapping of other layers.

In an aspect, the spatial coupling of code blocks between different precoding groups provides spatial diversity for a code block while allowing improved SINR from the GMD precoding and the use of SIC, while also having lower complexity than a single precoding group with the same number of layers. Further, across different GGMD groups, different SNRs are expected. Distributing a code block across two GGMD groups may bring some diversity gain if the cross group imbalance is not big. Various spatial coupling schemes may be used to split code blocks across the different precoding groups.

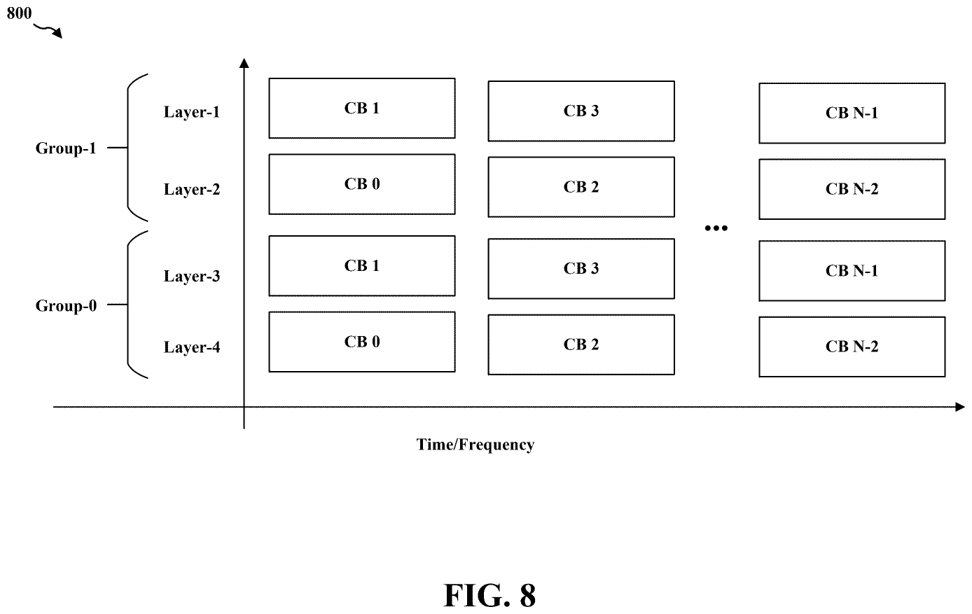

FIG. 8 is a diagram 800 of a first example code block spatial coupling scheme with a single codeword for each code block. Each code block can be split into a number of parts and directly coupled across the different precoding groups. For example, as illustrated, there are two precoding groups (group #0 and group #1), and each group includes two layers. A first part of a first code block (CB0) can be mapped on layer-4 in group #0 and spatially coupled with a second part of the first code block (CB0) on layer-2 in group #1. Similarly, a second code block (CB1) can be mapped on layer-3 in group #0 and layer-2 in group #1. Other code blocks can be mapped on different frequency and time resources. Although two precoding groups are illustrated, a code block may be split into N parts among N precoding groups and mapped to one layer in each precoding group. One code block is mapped to each layer, so different code blocks do not occupy the same layer in every precoding group.

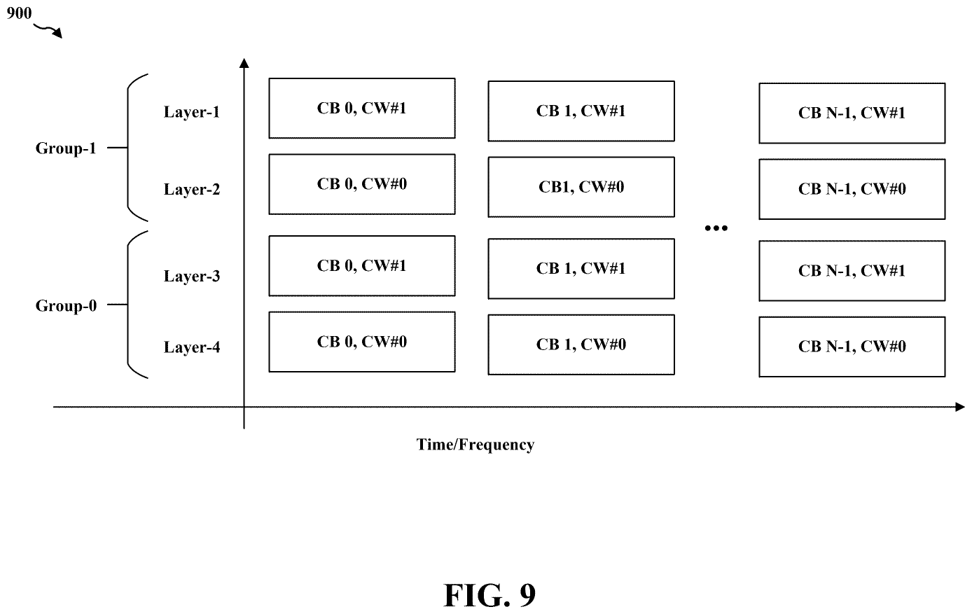

FIG. 9 is a diagram of a second example code block spatial coupling scheme 900 with multiple codewords per code block. Each code block can have multiple codewords with the same modulation and coding scheme (MCS). Each codeword is split across layers within a precoding group. Each codeword is split between the precoding groups. Accordingly, each precoding group can include a respective part for a codeword on each layer. Each codeword can be mapped to different time and frequency resources. For example, as illustrated, there are two precoding groups (group #0 and group #1), and each group includes two layers. A first part of a first codeword (CW #0) of a first code block (CB0) can be mapped on layer-4 in group #0 and spatially coupled with a second part of the first codeword (CW #0) of the first code block (CB0) on layer-2 in group #1. A second part of a second codeword (CW #1) of the first code block (CB0) can be mapped on layer-3 in group #0 and spatially coupled with a second part of the second codeword (CW #1) of the first code block (CB0) on layer-1 in group #1. Once again, although two precoding groups are illustrated, a code block may be split into N parts among N precoding groups and mapped to one layer in each precoding group. Additionally, a number of codewords corresponding to the number of layers in each precoding group may be used.

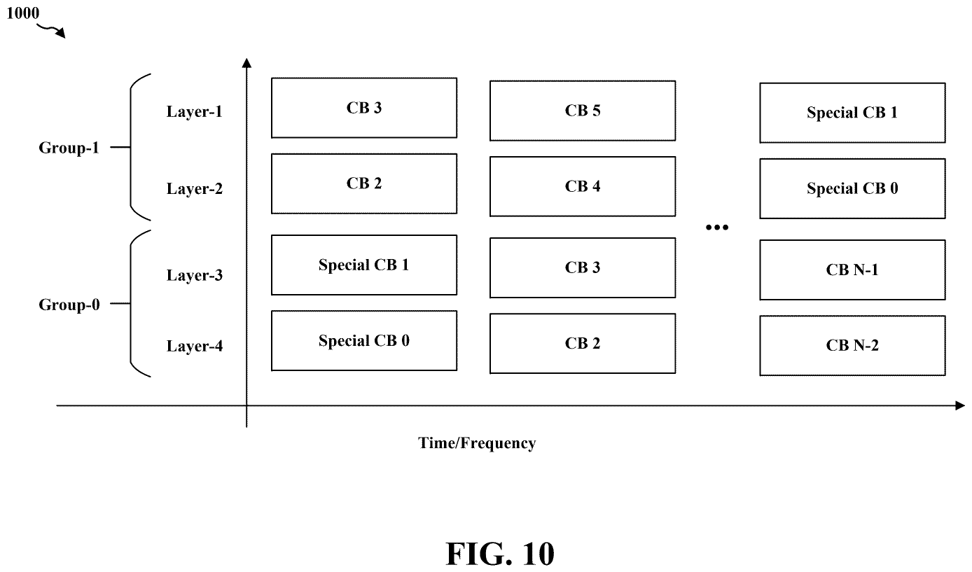

FIG. 10 is a diagram of a third example code block spatial coupling scheme 1000 with staggered code blocks. The code blocks may have a single codeword or a number of codewords corresponding to a number of layers in each precoding group. The code blocks are split between different layers on different frequency or time resources. The code blocks are staggered by an amount of frequency or time resources that a code block occupies on one layer. The staggering helps if the receiver cannot null out cross group interference, for example, due to channel state information (CSI) aging. That is, each part of the code block may not experience the cross group interference from the other part(s). Additionally, a first code block or set of code blocks on a first precoding group may be a special code block that is easier to decode. Accordingly, SIC may be used to remove the cross group interference after the special code block(s) are decoded. Then, due to the staggering, SIC may be used to remove cross group interference as each code block (or group thereof) is decoded for each precoding group.

For example, as illustrated, there are two precoding groups (group #0 and group #1), and each group includes two layers. A first part of a first code block (CB0) can be mapped on layer-4 in group #0. The first code block (CB0) may be a special code block that can be decoded based on the first part. For example, a special code block may have a lower MCS or include known bits. A second part of the first code block may be mapped on the second precoding group #1 on different frequency and time resources that are offset by more than the resources for a single code block (e.g., after other code blocks). A second code block (CB1) or a second codeword of the first code block (not shown) can be mapped on another layer of the first precoding group and also be considered a special code block. A first part of a different code block (CB2) may be mapped on layer-2 of group #1, and a first part of code block (CB3) may be mapped on layer-1 of group #1. Accordingly, a first part of a different code block may be mapped to each layer. At the receiver, because the special CB0 and CB1 should be decoded, SIC may be used to remove the cross group interference to the first parts of CB2 and CB3. In a second group of frequency and time resources, the second part of CB2 and CB3 may be mapped to layers in the first precoding group. The CB2 and CB3 may be decoded before CB4 and CB5 and SIC may be used to remove the cross group interference.

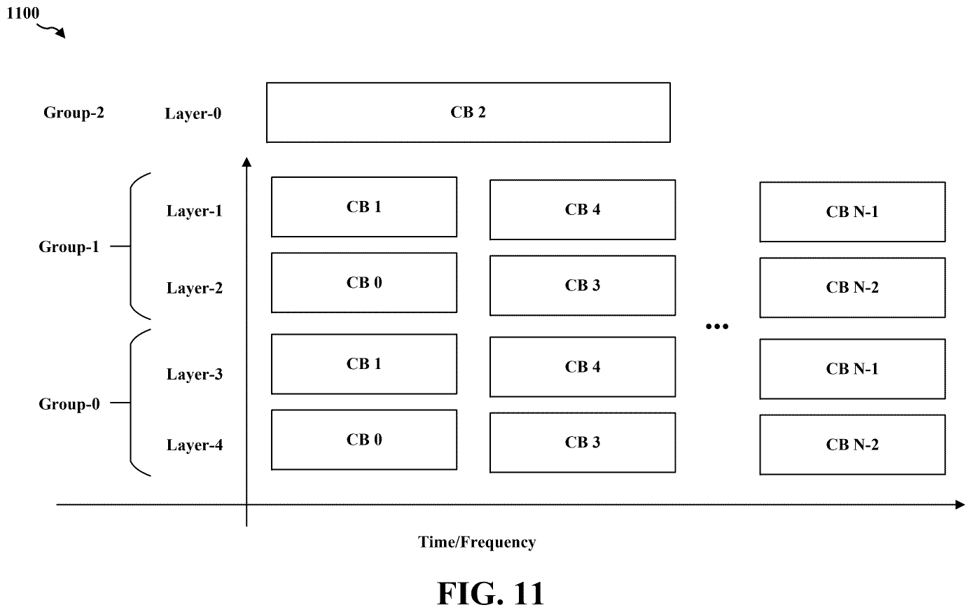

FIG. 11 is a diagram of a fourth example code block spatial coupling scheme 1100 with additional precoding groups. A transceiver may be capable of supporting different numbers of precoding groups. Depending on the capabilities and potential SNR differences among precoding groups, fewer than all of the precoding groups may be spatially coupled. For example, spatial coupling may provide greater gain when the precoding groups have very different SNRs. Spatial coupling between precoding groups with similar SNR may add complexity or delay with less gain. A DFE demapper can work independently if the precoding group is not coupled with another group.

As illustrated, precoding group #1 and precoding group #2 may be spatially coupled, whereas precoding group #2 is independent. For instance, the coupling scheme of FIG. 8 may be applied to group precoding group #1 and precoding group #2, but not group #2. Further, because group #2 is not spatially coupled, a CB2 with a same MCS as CB0 and CB1 may use more resources on layer-0 of group #2 because the CB2 is not split between layers in different groups.

In an aspect, network signaling such as a downlink control information (DCI) may indicate a subset of precoding groups having spatially coupled code blocks. The signaling may rely on assumptions or constraints of the code block spatial coupling schemes. For example, the subset of precoding groups needs to have the same number or a similar number of layers because each code block is split and mapped to one layer for each precoding group and different code blocks do not occupy the same layer in every precoding group. Additionally, as noted above, for the spatially coupled precoding groups, because one code block is mapped into multiple precoding groups, the time/frequency resources the code block occupies is smaller than the other code blocks in different spatially coupled precoding groups (e.g., with fewer spatially coupled precoding groups) or non-spatially coupled precoding groups. For example, in FIG. 11, the CB2 occupies twice as many resources on layer 0 than CB1 because CB1 is split among two layers. Since the DFE demappers for different precoding groups work independently, demapping and decoding of different CBs on different resources is feasible. Within the subset of spatially coupled precoding groups, however, the DFE demappers need to be coordinated to decode a CB one layer after another layer.

In some implementations, the DCI may include a field for a coupling group that indicates which precoding groups are spatially coupled within the coupling group. For instance, the field may include a bitmap where each bit indicates whether a corresponding precoding group is a member of the coupling group. The DCI may be configured to include a number of such fields corresponding to a number of coupling groups supported. For example, if two coupling groups are supported, a first field may have a value of “1100” indicating that a first precoding group is spatially coupled with a second precoding group and a second field may have a value of “0011” indicating that a third precoding group and a fourth precoding group are spatially coupled.

When two spatially coupled precoding groups have a similar, but different number of layers, a number of layers (N) less than or equal to the number of layers in a smallest precoding group may be spatially coupled. For each coupling group, the number of layers (N) to be coupled may be predetermined or based on a DCI indication. For instance, a standards document or regulation may specify that the number of layers (N1) in the smallest precoding group (least number of layers) is coupled. Alternatively, the DCI may include a field that indicates the number of coupled layers (N). Similarly, which layers are spatially coupled may be predetermined or based on a DCI indication. For instance, the first N layers in each precoding group or the last N layers in each precoding group may be specified in a standards document or regulation. Alternatively, the DCI may have a field that indicates a layer offset or index for each precoding group in the coupling group. For example, in an implementation, a DCI may have a first field for a coupling group that indicates which precoding groups are spatially coupled within the coupling group, a second field that indicates the number of coupled layers, and a third field that indicates an offset or index of the spatially coupled layers.

In an aspect, a code block spatial coupling scheme may be selected based on capabilities of a receiving device (e.g., a UE). For instance, a receiving device may include a number of DFE demappers corresponding to a number of precoding groups supported. To support code block spatial coupling, the DFE demappers for spatially coupled layers should be coordinated to provide the demapped symbols to the decoder. The demappers may also be coordinated to wait for SIC of previously decoded code blocks. The receiving device may transmit a capability message (e.g., a RRC capability response) that indicates supported parameters for code block spatial coupling. For instance, the capability parameters may include a number of supported precoding groups for coupling, a maximum number of layers per precoding group, and a maximum number of coupling groups.

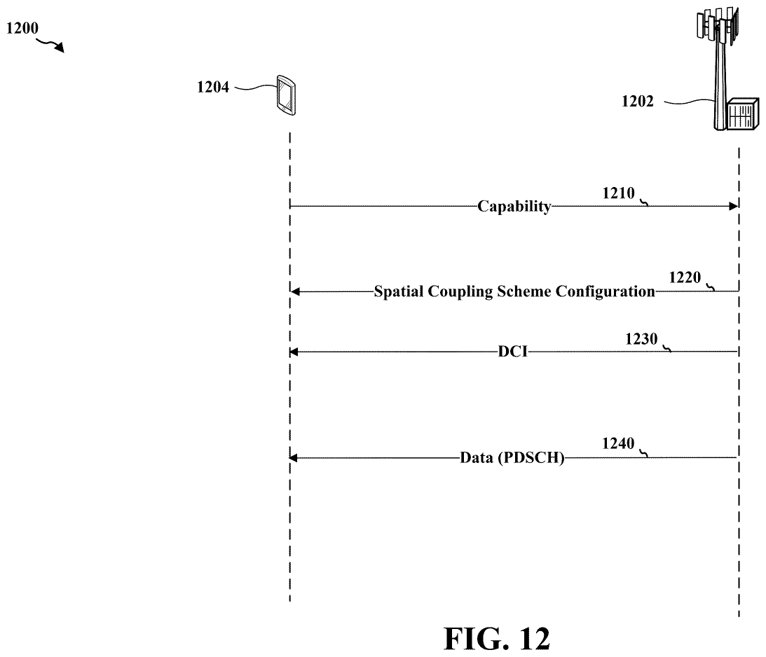

FIG. 12 is a message diagram 1200 illustrating configuration of a UE 1204 for communication with spatially coupled code blocks for precoding groups. The UE 1204 may communicate with a network entity 1202.

The UE 1204 may transmit a capability message 1210 that indicates a capability of the UE 1404 to support spatially coupled code blocks for precoding groups. For example, the capability message 1210 may indicate one or more of a number of supported precoding groups for coupling, a maximum number of layers per precoding group, or a maximum number of coupling groups. The capability message 1210 may be, for example, a RRC capability response message.

The network entity 1212 may transmit a spatial coupling scheme configuration 1220. For example, the spatial coupling scheme configuration 1220 may be an RRC message or an information element of an RRC message. The spatial coupling scheme configuration 1220 may indicate semi-persistent parameters for spatially coupled code blocks for precoding groups. For instance, the number of precoding groups may be configured semi-statically. The spatial coupling scheme configuration 1220 may indicate a size of a DCI format or a size of fields within a DCI format for scheduling transmissions with spatial coupling for precoding groups.

The network entity 1202 may transmit a DCI 1230. The DCI 1230 may schedule a data transmission 1240 such as a PDSCH with spatially coupled code blocks for precoding groups. The DCI 1230 may include one or more fields that define a spatial coupling scheme. For example, the DCI 1230 may include one or more of a field that indicates which precoding groups are spatially coupled within a coupling group, a field that indicates a number of coupled layers, or a field that indicates an offset or index of the spatially coupled layers. In implementations where there are multiple coupling groups, the DCI may include a set of fields for each coupling group.

The network entity 1202 may transmit a data transmission 1240 with spatially coupled code blocks for precoding groups. For example, the network entity 1202 may transmit a physical downlink shared channel (PDSCH) that uses a spatial coupling scheme as illustrated in any of FIGS. 8-11. That is, the data transmission 1240 may have code blocks mapped according to one or more coupling groups, each including two or more precoding groups having one or more layers. At least one code block is split between layers in separate precoding groups such that the layers are spatially coupled.

The UE 1204 may receive the data transmission 1240 and demap the code blocks according to the spatial coupling scheme. In particular, the UE 1204 may demap the layers spatially coupled layers in different demappers and provide the LLRs for each part of the code block to the decoder. In some implementations, the UE 1204 may further perform SIC on the decoded code block to cancel a signal corresponding to the decoded code block from the received signal to improve demapping of other layers.

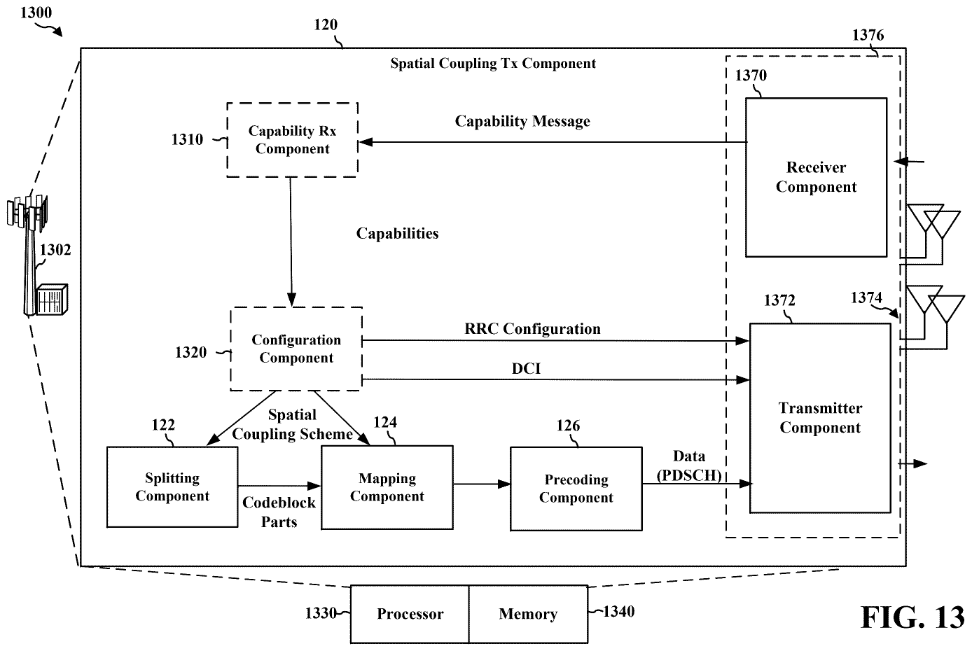

FIG. 13 is a conceptual data flow diagram 1300 illustrating the data flow between different means/components in an example network entity 1302 including a spatial coupling Tx component 120. For example, the network entity 1302 may be an example of a network node such as the base station 102 (FIG. 1) including the spatial coupling Tx component 120. In some implementations, the spatial coupling Tx component 120 may be implemented by the memory 376 and the TX processor 316, the RX processor 370, and/or the controller/processor 375 of FIG. 3. For example, the memory 376 may store executable instructions defining the spatial coupling Tx component 120 and the TX processor 316, the RX processor 370, and/or the controller/processor 375 may execute the instructions. In other implementations, the spatial coupling Tx component 120 may be implemented on computing resources including one or more processors 1330 and one or more memories 1340. For example, the spatial coupling Tx component 120 may be implemented on a virtual CU or virtual DU in a datacenter.

As discussed with respect to FIG. 1, the spatial coupling Tx component 120 may include the splitting component 122, the mapping component 124, and the precoding component 126. In some implementations, the spatial coupling Tx component 120 may optionally include a capability Rx component and/or a configuration component 1320.

The network entity 1302 may include a receiver component 1370, which may include, for example, a radio frequency (RF) receiver for receiving the signals described herein. The network entity 1302 may include a transmitter component 1372, which may include, for example, an RF transmitter for transmitting the signals described herein. The transmitter component 1372 may output RF signals to one or more antennas 1374. In an aspect, the receiver component 1370 and the transmitter component 1372 may be co-located in a transceiver 1376, which may correspond to the TX/RX 318 in FIG. 3.

The capability Rx component 1310 is configured to receive a capability message indicating a capability of a user equipment with respect to code block spatial coupling for precoding groups. For example, the capability Rx component 1310 may receive the capability message 1210 via the receiver component 1370. For instance, the capability message 1210 may be an RRC message. In some implementations, the capability Rx component 1310 may request the capability message 1210 by transmitting a capability request message. The capability Rx component 1310 may output the capability of the UE to the configuration component 1320.

The configuration component 1320 is configured to transmit one or more configuration messages that configure a UE to receive a message according to a spatial coupling scheme. The spatial coupling scheme may be selected based on the capabilities of the UE. In some implementations, the configuration component 1320 may output an RRC configuration message (e.g., spatial coupling scheme configuration 1220) that semi-statically configures parameters for code block spatial coupling for precoding groups. For example, the spatial coupling scheme configuration 1220 may configure a number of coupling groups or a DCI format for scheduling with spatial coupling. The configuration component 1320 may output a DCI 1230 that schedules a transmission with spatial coupling for precoding groups. The DCI 1230 may indicate parameters of a spatial coupling scheme such as which precoding groups are in a coupling group, how many layers are coupled, or which layers are coupled. The configuration component 1320 may output the spatial coupling scheme configuration 1220 and/or the DCI 1230 for transmission via the transmitter component 1372. The configuration component 1320 may also output the spatial coupling scheme to the splitting component 122 and the mapping component 124.

The splitting component 122 is configured to split a code block into a number of parts corresponding to a number of precoding groups. For example, the splitting component 122 may obtain the number of precoding groups in the spatial coupling scheme. For each code block that is to be mapped to spatially coupled layers, the splitting component 122 may generate a part of the code block corresponding to one of the layers. The splitting component 122 may generate at least a first code block part and a second code block part. The splitting component 122 may output the code block parts to the mapping component 124.

The mapping component 124 is configured to mapping each part of the code block to a spatially coupled layer within a respective precoding group. The mapping component 124 may obtain the code block parts from the splitting component 122 and obtain the spatial coupling scheme from the configuration component 1320. The mapping component 124 maps each code block part to a spatially coupled layer based on the spatial coupling scheme. That is, the mapping component 124 maps the coded bits in the code block parts to the spatial layer and time/frequency resources corresponding to each precoding group. The mapping component 124 may also map code blocks that are not spatially coupled to respective spatial layers and time/frequency resources. In some implementations, the mapping component 124 may perform further processing such as symbol modulation and the IFFT to produce a time-domain symbol stream. Alternatively, the further processing may be performed by separate components (not shown). The time-domain symbol stream is output to the precoding component 126.

The precoding component 126 is configured to transmit the code block across the mapped layers via different precoders for the precoding groups. For instance, the precoding component 126 may obtain the resource elements (REs) from the mapping component 124. The precoding component 126 may include a precoder for each precoding group. In some implementations, the precoding component 126 may also include a SVD precoder. The precoding component 126 may apply the precoders to each layer to produce the data transmission 1240. The data transmission 1240 is a multi-layer MIMO transmission that is transmitted via the transmitter component 1372 and antennas 1374.

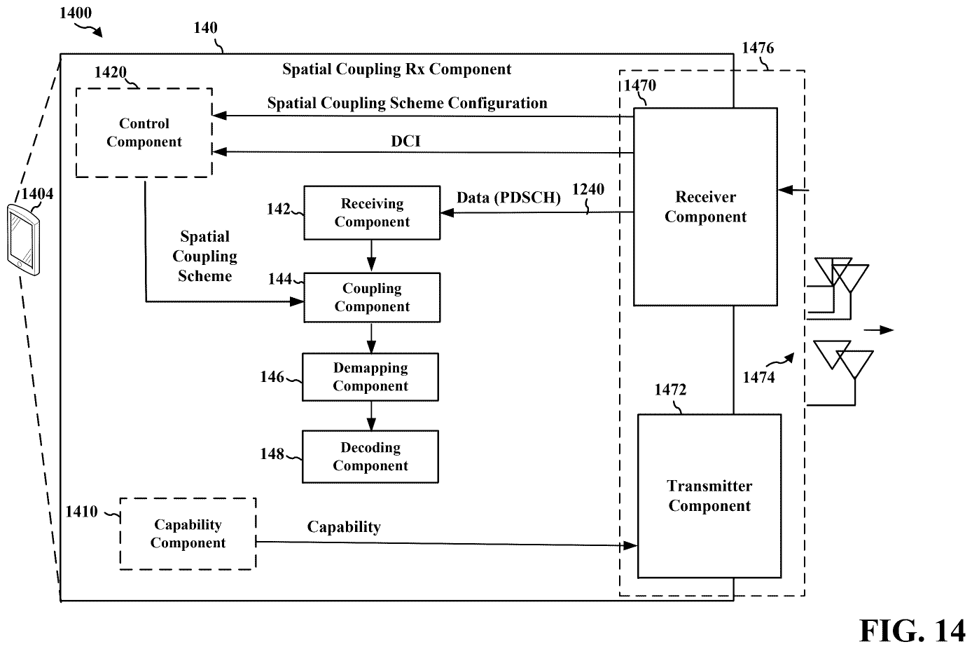

FIG. 14 is a conceptual data flow diagram 1400 illustrating the data flow between different means/components in an example UE 1404 including a spatial coupling Rx component 140. For example, the UE 1404 may be an example of a wireless node such as the UE 104 (FIG. 1) including the spatial coupling Rx component 140. The spatial coupling Rx component 140 may be implemented by the memory 360 and the TX processor 368, the RX processor 356, and/or the controller/processor 368 of FIG. 3. For example, the memory 360 may store executable instructions defining the spatial coupling Rx component 140 and the TX processor 368, the RX processor 356, and/or the controller/processor 359 may execute the instructions.

The UE 1404 may include a receiver component 1470, which may include, for example, a radio frequency (RF) receiver for receiving the signals described herein. The UE 1404 may include a transmitter component 1472, which may include, for example, an RF transmitter for transmitting the signals described herein. The transmitter component 1472 may output RF signals to one or more antennas 1474. In an aspect, the UE 1404 and the transmitter component 1472 may be co-located in a transceiver 1476, which may correspond to the TX/RX 354 in FIG. 3.

As discussed with respect to FIG. 1, the spatial coupling Rx component 140 may include the receiving component 142, the coupling component 144, the demapping component 146, and the decoding component 148. The spatial coupling Rx component 140 may optionally include a capability component 1410 and/or a control component 1420.

The receiver component 1470 may receive signals from a network entity such as a base station 102. For example, the receiver component 1470 may receive the spatial coupling scheme configuration 1220, the DCI 1230, and/or the data transmission 1240. The receiver component 1470 may provide the spatial coupling scheme configuration 1220 and/or the DCI 1230 to the control component 1420. The receiver component 1470 may provide the data transmission 1240 to the receiving component 142.

The capability component 1410 is configured to transmit a capability message indicating a capability of a user equipment with respect to code block spatial coupling for precoding groups. The capability component 1410 may generate the capability message 1210 based on the demapping capabilities of the demapping component 146 (e.g., a number of demappers and level of coordination among the demappers). For instance, the capability message 1210 may indicate one or more of a number of supported precoding groups for coupling, a maximum number of layers per precoding group, or a maximum number of coupling groups. The capability component 1410 may output the capability message 1210 for transmission via the transmitter component 1472 as a n RRC capability response message.

The control component 1420 is configured to receive configuration information for spatially coupled code blocks for precoding groups. For instance, the control component 1420 may receive the spatial coupling scheme configuration 1220 and/or the DCI 1230. The control component 1420 may obtain parameters of a spatial coupling scheme from the received messages. The control component 1420 may output the configured spatial coupling scheme for a transmission to the coupling component 144.

The receiving component 142 is configured to receive a data transmission 1240 that includes at least one code block that is split among layers of different precoding groups. The receiving component 142 may receive at least a first part of the code block on a first layer of a first precoding group and receive a second part of the code block on a second layer of a second precoding group. The receiving component 142 may output the received data transmission 1240 to the coupling component 144.

The coupling component 144 is configured to determine which layers of the received data transmission 1240 are spatially coupled. The coupling component 144 may obtain the spatial coupling scheme from the control component 1420. The coupling component 144 may identify the precoding groups and corresponding layers that are spatially coupled. The coupling component 144 may output the spatially coupled precoding groups and corresponding layers to the demapping component 146.

The demapping component 146 is configured to demap each part of the spatially coupled code block. The demapping component 146 may include a separate demapper for each spatially coupled precoding group. The demapping component 146 may demap the spatially coupled layers of each precoding group to determine LLRs for the symbols of the code block. The demapping component 146 may output the LLRs corresponding each part of the code block to the decoding component 148. For instance, the demapping component may output at least the LLRs corresponding to the first part of the code block and the LLRs corresponding to the second part of the code block to the decoding component 148.

The decoding component 148 is configured to decode the code block based on the first part and the second part. For example, the decoding component 148 may correspond to the decoder 750. The LLRs of each part of the spatially coupled code block correspond to each of the symbols of the code block. Accordingly, the decoding component 148 may decode the code block based on the coding scheme. The decoding component 148 may output the decoded code block to higher layers. In some implementations, the decoding component 148 may output the decoded code block to a re-encoder 760 (FIG. 7) to implement SIC to improve demapping of other layers.

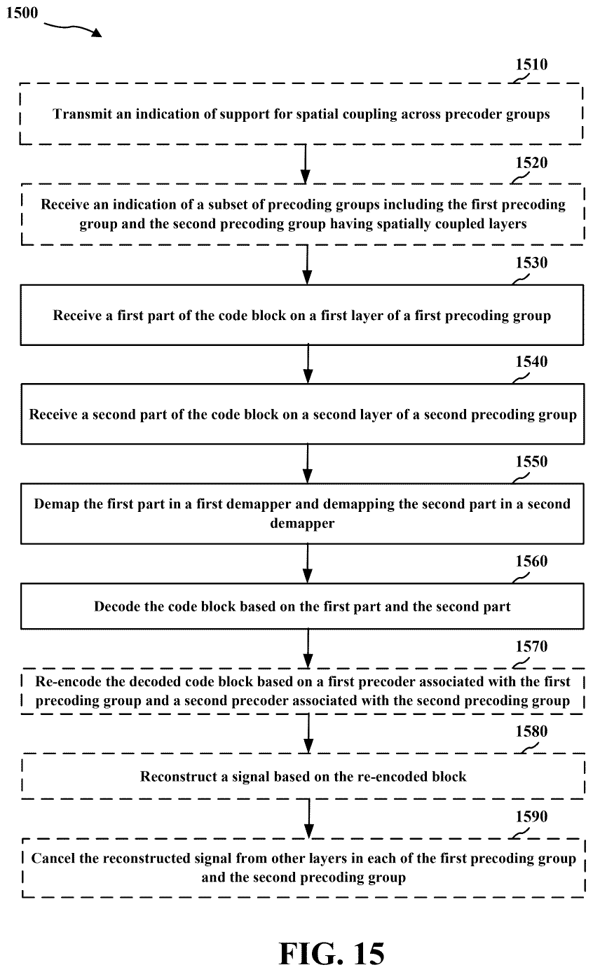

FIG. 15 is a flowchart of an example method 1500 for a wireless node such as a UE to receive a wireless transmission with spatially coupling for precoding groups. The method 1500 may be performed by a UE (such as the UE 104, which may include the memory 360 and which may be the entire UE 104 or a component of the UE 104 such as the spatial coupling Rx component 140, TX processor 368, the RX processor 356, or the controller/processor 359). The method 1500 may be performed by the spatial coupling Rx component 140 in communication with the spatial coupling Tx component 120 at a network entity. Optional blocks are shown with dashed lines.

At block 1510, the method 1500 may optionally include transmitting an indication of support for spatial coupling across precoder groups. In some implementations, for example, the UE 104, the Tx processor 368 or the controller/processor 359 may execute the spatial coupling Rx component 140 or the capability component 1410 to transmit an indication (e.g., capability message 1210) of support for spatial coupling across precoder groups. In some implementations, the capability message indicates a maximum number of codes of the first polar code kernel type. In some implementations, the indication of support indicates one or more of a number of precoding groups for spatial coupling, a maximum number of layers in a precoding group, or a maximum number of coupling groups. Accordingly, the UE 104, the TX processor 368, or the controller/processor 359 executing the spatial coupling Rx component 140 or the capability component 1410 may provide means for transmitting an indication of support for spatial coupling across precoder groups.

At block 1520, the method 1500 may optionally include receiving an indication of a subset of precoding groups including the first precoding group and the second precoding group having spatially coupled layers. In some implementations, for example, the UE 104, the RX processor 356, or the controller/processor 359 may execute the spatial coupling Rx component 140 or the control component 1420 to receive the indication (e.g., DCI 1230) of a subset of precoding groups including the first precoding group and the second precoding group having spatially coupled layers. In some implementations, the indication includes a quantity of spatially coupled precoding groups in a coupling group and an indication of which precoding groups are in the coupling group. Accordingly, the UE 104, the RX processor 356, or the controller/processor 359 executing the spatial coupling Rx component 140 or the control component 1420 may provide means for receiving an indication of a subset of precoding groups including the first precoding group and the second precoding group having spatially coupled layers.

At block 1530, the method 1500 includes receiving a first part of the code block on a first layer of a first precoding group. In some implementations, for example, the UE 104, the RX processor 356 or the controller/processor 359 may execute the spatial coupling Rx component 140 or the receiving component 142 to receive the first part of the code block on a first layer of a first precoding group. Accordingly, the UE 104, the RX processor 356, or the controller/processor 359 executing the spatial coupling Rx component 140 or the receiving component 142 may provide means for receiving a first part of the code block on a first layer of a first precoding group.

At block 1540, the method 1500 includes receiving a second part of the code block on a second layer of a second precoding group. The second layer is spatially coupled with the first layer of the first precoding group. In some implementations, for example, the UE 104, the RX processor 356 or the controller/processor 359 may execute the spatial coupling Rx component 140 or the receiving component 142 to receive a second part of the code block on a second layer of a second precoding group.

For example, in some implementations, the first precoding group is associated with a first generalized geometric mean decomposition (GGMD) precoder and the second precoding group is associated with a second GGMD precoder. In some implementations, the second layer of the second precoding group is spatially coupled with the first layer of the first precoding group when a difference between a signal to noise ratio of the first precoding group and a signal to noise ratio of the second precoding group satisfies a threshold.

In some implementations, the first precoding group includes a different number of layers than the second precoding group. For example, the number of layers that are coupled between the first precoding group and the second precoding group can be a number of layers of in the precoding group with a fewest number of layers. As another example, the DCI received in block 1520 may include an indication of the number of layers that are coupled between the first precoding group and the second precoding group. In some implementations, the number of layers that are coupled between the first precoding group and the second precoding group include contiguous layers starting at a first layer index or an offset from the first layer that is predefined or indicated by a DCI (e.g., as received in block 1520).

In view of the foregoing, the UE 104, the RX processor 356, or the controller/processor 359 executing the spatial coupling Rx component 140 or the receiving component 142 may provide means for receiving a second part of the code block on a second layer of a second precoding group.

At block 1550, the method 1500 includes demapping the first part in a first demapper and demapping the second part in a second demapper. In some implementations, for example, the UE 104, the RX processor 356, or the controller/processor 359 may execute the spatial coupling Rx component 140 or the demapping component 146 to demap the first part in a first demapper and demapping the second part in a second demapper.

In some implementations, each layer in the first precoding group is mapped to a separate code block with a single codeword and a corresponding layer in the second precoding group is mapped to the single codeword. Alternatively, in some implementations, each layer in the first precoding group is mapped to a different codeword of the code block and each codeword is mapped to a corresponding layer in the second precoding group, each codeword of the code block having a same modulation and coding scheme. In some implementations, the second part of the code block on the second layer in the second precoding group is offset in time, frequency, or both from the first part of the code block on the first layer in the first precoding group. The second part of the code block may be offset when either a single codeword or different codewords are used.

Accordingly, the UE 104, the RX processor 356, or the controller/processor 359 executing the spatial coupling Rx component 140 or the demapping component 146 may provide means for demapping the first part in a first demapper and demapping the second part in a second demapper.

At block 1560, the method 1500 includes decoding the code block based on the first part and the second part. In some implementations, for example, the UE 104, the RX processor 356, or the controller/processor 359 may execute the spatial coupling Rx component 140 or the decoding component 148 to decode the code block based on the first part and the second part. Accordingly, the UE 104, the RX processor 356, or the controller/processor 359 executing the spatial coupling Rx component 140 or the decoding component 148 may provide means for decoding the code block based on the first part and the second part.

At block 1570, the method 1500 may optionally include re-encoding the decoded code block based on a first precoder associated with the first precoding group and a second precoder associated with the second precoding group. In some implementations, for example, the UE 104, the RX processor 356, or the controller/processor 359 may execute the spatial coupling Rx component 140 or the re-encoder 760 to re-encode the decoded code block based on a first precoder associated with the first precoding group and a second precoder associated with the second precoding group. Accordingly, the UE 104, the RX processor 356, or the controller/processor 359 executing the spatial coupling Rx component 140 or the re-encoder 760 may provide means for re-encoding the decoded code block based on a first precoder associated with the first precoding group and a second precoder associated with the second precoding group.

At block 1580, the method 1500 may optionally include reconstructing a signal based on the re-encoded block. In some implementations, for example, the UE 104, the RX processor 356, or the controller/processor 359 may execute the spatial coupling Rx component 140 or the re-encoder 760 to reconstruct a signal based on the re-encoded block. Accordingly, the UE 104, the RX processor 356, or the controller/processor 359 executing the spatial coupling Rx component 140 or the re-encoder 760 may provide means for reconstructing a signal based on the re-encoded block.

At block 1590, the method 1500 may optionally include cancelling the reconstructed signal from other layers in each of the first precoding group and the second precoding group. In some implementations, for example, the UE 104, the RX processor 356, or the controller/processor 359 may execute the spatial coupling Rx component 140 or the receiving component 142 to cancel the reconstructed signal from other layers in each of the first precoding group and the second precoding group. Accordingly, the UE 104, the RX processor 356, or the controller/processor 359 executing the spatial coupling Rx component 140 or the receiving component 142 may provide means for cancelling the reconstructed signal from other layers in each of the first precoding group and the second precoding group.

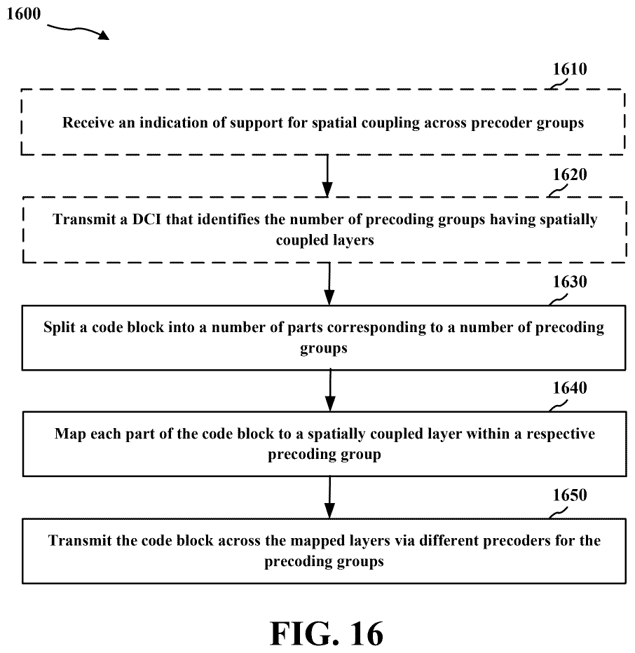

FIG. 16 is a flowchart of an example method 1600 for a wireless node such as a network entity to transmit data with spatial coupling for precoding groups. The method 1600 may be performed by a network entity 1302 such as a base station (such as the base station 102, which may include the memory 376 and which may be the entire base station 102 or a component of the base station 102 such as a DU 430 including the spatial coupling Tx component 120, TX processor 316, RX processor 370, or the controller/processor 375). The method 1600 may be performed by the spatial coupling Tx component 120 in communication with the spatial coupling Rx component 140 at a UE. Optional blocks are shown with dashed lines.

At block 1610, the method 1600 may optionally include receiving an indication of support for spatial coupling across precoder groups. In some implementations, for example, the base station 102, the RX processor 370 or the controller/processor 375 may execute the spatial coupling Tx component 120 or the capability Rx component 1310 to receive the capability message 1210 indicating support for spatial coupling across precoder groups. Accordingly, the base station 102, the RX processor 370 or the controller/processor 375 executing the spatial coupling Tx component 120 or the capability Rx component 1310 may provide means for receiving an indication of support for spatial coupling across precoder groups.

At block 1620, the method 1600 may optionally include transmitting a DCI that identifies the number of precoding groups having spatially coupled layers. In some implementations, for example, the base station 102, the TX processor 316, or the controller/processor 375 may execute the spatial coupling Tx component 120 or the configuration component 1320 to transmit a DCI that identifies the number of precoding groups having spatially coupled layers. Accordingly, the base station 102, the TX processor 316, or the controller/processor 375 executing the spatial coupling Tx component 120 or the configuration component 1320 may provide means for transmitting a DCI that identifies the number of precoding groups having spatially coupled layers.

At block 1630, the method 1600 includes splitting a code block into a number of parts corresponding to a number of precoding groups. In some implementations, for example, the base station 102, the TX processor 316, or the controller/processor 375 may execute the spatial coupling Tx component 120 or the splitting component 122 to split a code block into a number of parts corresponding to a number of precoding groups. Accordingly, the base station 102, the TX processor 316, or the controller/processor 375 executing the spatial coupling Tx component 120 or the splitting component 122 may provide means for splitting a code block into a number of parts corresponding to a number of precoding groups.

At block 1640, the method 1600 may optionally include mapping each part of the code block to a spatially coupled layer within a respective precoding group. In some implementations, for example, the base station 102, the TX processor 316, or the controller/processor 375 may execute the spatial coupling Tx component 120 or the mapping component 124 to map each part of the code block to a spatially coupled layer within a respective precoding group. Accordingly, the base station 102, the TX processor 316, or the controller/processor 375 executing the spatial coupling Tx component 120 or the mapping component 124 may provide means for mapping each part of the code block to a spatially coupled layer within a respective precoding group.

At block 1650, the method 1600 includes transmitting the code block across the mapped layers via different precoders for the precoding groups. In some implementations, for example, the base station 102, the TX processor 316, or the controller/processor 375 may execute the spatial coupling Tx component 120 or the precoding component 126 to transmit the code block across the mapped layers via different precoders for the precoding groups. Accordingly, the base station 102, the TX processor 316, or the controller/processor 375 executing the spatial coupling Tx component 120 or the precoding component 126 may provide means for transmitting the code block across the mapped layers via different precoders for the precoding groups.

The following numbered clauses provide an overview of aspects of the present disclosure:
Clause 1. A method of receiving a code block, comprising: receiving a first part of the code block on a first layer of a first precoding group; receiving a second part of the code block on a second layer of a second precoding group, the second layer spatially coupled with the first layer of the first precoding group; demapping the first part in a first demapper and demapping the second part in a second demapper; and decoding the code block based on the first part and the second part.
Clause 2. The method of clause 1, wherein the first precoding group is associated with a first generalized geometric mean decomposition (GGMD) precoder and the second precoding group is associated with a second GGMD precoder.
Clause 3. The method of clause 1 or 2, further comprising: re-encoding the decoded code block based on a first precoder associated with the first precoding group and a second precoder associated with the second precoding group; reconstructing a signal based on the re-encoded block; and cancelling the reconstructed signal from other layers in each of the first precoding group and the second precoding group.
Clause 4. The method of any of clauses 1-3, wherein each layer in the first precoding group is mapped to a separate code block with a single codeword and a corresponding layer in the second precoding group is mapped to the single codeword.
Clause 5. The method of any of clauses 1-3, wherein each layer in the first precoding group is mapped to a different codeword of the code block and each codeword is mapped to a corresponding layer in the second precoding group, each codeword of the code block having a same modulation and coding scheme.
Clause 6. The method of any of clauses 1-5, wherein the second part of the code block on the second layer in the second precoding group is offset in time, frequency, or both from the first part of the code block on the first layer in the first precoding group.
Clause 7. The method of any of clauses 1-6, wherein the second layer of the second precoding group is spatially coupled with the first layer of the first precoding group when a difference between a signal to noise ratio of the first precoding group and a signal to noise ratio of the second precoding group satisfies a threshold.
Clause 8. The method of any of clauses 1-7, further comprising receiving an indication (DCI) of a subset of precoding groups including the first precoding group and the second precoding group having spatially coupled layers.
Clause 9. The method of clause 8, wherein the indication includes a quantity of spatially coupled precoding groups in a coupling group and an indication of which precoding groups are in the coupling group.
Clause 10. The method of any of clauses 1-9, wherein the first precoding group includes a different number of layers than the second precoding group, wherein a number of layers that are coupled between the first precoding group and the second precoding group is a number of layers of in the precoding group with a fewest number of layers.
Clause 11. The method of any of clauses 1-9, wherein the first precoding group includes a different number of layers than the second precoding group, further comprising receiving an indication of a number of layers that are coupled between the first precoding group and the second precoding group.
Clause 12. The method of any of clauses 1-11, wherein a number of layers that are coupled between the first precoding group and the second precoding group include contiguous layers starting at a first layer index or an offset from the first layer that is predefined or indicated by a downlink control information.
Clause 13. The method of any of clauses 1-12, further comprising transmitting an indication of support for spatial coupling across precoder groups.
Clause 14. The method of clause 13, wherein the indication of support indicates one or more of a number of precoding groups for spatial coupling, a maximum number of layers in a precoding group, or a maximum number of coupling groups.
Clause 15. A method of transmitting a code block, comprising: splitting a code block into a number of parts corresponding to a number of precoding groups; mapping each part of the code block to a spatially coupled layer within a respective precoding group; and transmitting the code block across the mapped layers via different precoders for the precoding groups.
Clause 16. The method of clause 15, wherein each precoding group is associated with a generalized geometric mean decomposition (GGMD) precoder.
Clause 17. The method of clause 15 or 16, wherein each spatially coupled layer in the respective precoding group is mapped to a separate code block with a single codeword and a corresponding layer in another precoding group is mapped to the single codeword.
Clause 18. The method of clause 15 or 16, wherein each layer in the respective precoding group is mapped to a different codeword of the code block and each codeword is mapped to a corresponding layer in another precoding group, each codeword of the code block having a same modulation and coding scheme.
Clause 19. The method of any of clauses 15-1815, wherein the respective part of the code block on the respective layer in each subsequent precoding group is offset in time, frequency, or both from a first part of the code block on a first layer in a first precoding group.
Clause 20. The method of any of clauses 15-19, wherein the spatially coupled layers within different precoding groups are spatially coupled when a difference between signal to noise ratios of the different precoding groups satisfies a threshold.
Clause 21. The method of any of clauses 15-20, further comprising transmitting a downlink control information (DCI) that identifies the number of precoding groups having spatially coupled layers.
Clause 22. The method of clause 21, wherein the DCI indicates a quantity of spatially coupled precoding groups in a coupling group and which precoding groups are in the coupling group.
Clause 23. The method of any of clauses 15-225, wherein the precoding groups include different numbers of layers, wherein a number of layers that are coupled between the precoding groups is a number of layers in a precoding group with a fewest number of layers.
Clause 24. The method of any of clauses 15-22, wherein the precoding groups include different numbers of layers, further comprising transmitting an indication of a number of layers that are coupled between the precoding groups.
Clause 25. The method of any of clauses 15-24, wherein a number of layers that are coupled between the precoding groups include contiguous layers starting at a first layer index or an offset from the first layer index that is predefined or indicated by a downlink control information.
Clause 26. The method of any of clauses 15-25, further comprising receiving an indication of support for spatial coupling across precoder groups.
Clause 27. The method of clause 26, wherein the indication of support indicates one or more of a number of precoding groups for spatial coupling, a maximum number of layers in a precoding group, or a maximum number of coupling groups.
Clause 28. An apparatus for wireless communications, comprising means for performing a method in accordance with any one of clauses 1-14.
Clause 29 An apparatus for wireless communications, comprising means for performing a method in accordance with any one of clauses 15-27.
Clause 30. A non-transitory computer-readable medium comprising instructions that, when executed by a wireless node (e.g., a UE), cause the wireless node to perform a method in accordance with any one of clauses 1-14.
Clause 31. A non-transitory computer-readable medium comprising instructions that, when executed by a wireless node (e.g., network entity), cause the wireless node to perform a method in accordance with any one of clauses 15-27.
Clause 32. An apparatus for wireless communications, comprising: one or more memories, individually or in combination, having instructions; and one or more processors, individually or in combination, configured to execute the instructions and cause the apparatus to perform a method in accordance with any one of clauses 1-14.
Clause 33. An apparatus for wireless communications, comprising: one or more memories, individually or in combination, having instructions; and one or more processors, individually or in combination, configured to execute the instructions and cause the apparatus to perform a method in accordance with any one of clauses 15-27.

As used herein, a phrase referring to “at least one of” a list of items refers to any combination of those items, including single members. As an example, “at least one of: a, b, or c” is intended to cover: a, b, c, a-b, a-c, b-c, and a-b-c. Similarly, as used herein, a phrase referring to “one or more of” a list of items refers to any combination of those items, including single members. As an example, “one or more of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireless communication, comprising:
one or more memories; and
one or more processors coupled with one or more memories and configured, individually or in combination, to:
receive a first part of a code block on a first layer of a first precoding group;
receive a second part of the code block on a second layer of a second precoding group, the second layer spatially coupled with the first layer of the first precoding group;
demap the first part in a first demapper and demap the second part in a second demapper; and
decode the code block based on the first part and the second part.

2. The apparatus of claim 1, wherein the first precoding group is associated with a first generalized geometric mean decomposition (GGMD) precoder and the second precoding group is associated with a second GGMD precoder.

3. The apparatus of claim 1, wherein the one or more processors, individually or in combination, are further configured to:
re-encode the decoded code block based on a first precoder associated with the first precoding group and a second precoder associated with the second precoding group;
reconstruct a signal based on the re-encoded block; and
cancel the reconstructed signal from other layers in each of the first precoding group and the second precoding group.

4. The apparatus of claim 1, wherein each layer in the first precoding group is mapped to a separate code block with a single codeword and a corresponding layer in the second precoding group is mapped to the single codeword.

5. The apparatus of claim 1, wherein each layer in the first precoding group is mapped to a different codeword of the code block and each codeword is mapped to a corresponding layer in the second precoding group, each codeword of the code block having a same modulation and coding scheme.

6. The apparatus of claim 1, wherein the second part of the code block on the second layer in the second precoding group is offset in time, frequency, or both from the first part of the code block on the first layer in the first precoding group.

7. The apparatus of claim 1, wherein the second layer of the second precoding group is spatially coupled with the first layer of the first precoding group when a difference between a signal to noise ratio of the first precoding group and a signal to noise ratio of the second precoding group satisfies a threshold.

8. The apparatus of claim 1, further comprising receiving an indication (DCI) of a subset of precoding groups including the first precoding group and the second precoding group having spatially coupled layers.

9. The apparatus of claim 8, wherein the indication includes a quantity of spatially coupled precoding groups in a coupling group and an indication of which precoding groups are in the coupling group.

10. The apparatus of claim 1, wherein the first precoding group includes a different number of layers than the second precoding group, wherein a number of layers that are coupled between the first precoding group and the second precoding group is a number of layers of in the precoding group with a fewest number of layers.

11. The apparatus of claim 1, wherein the first precoding group includes a different number of layers than the second precoding group, wherein the one or more processors, individually or in combination, are further configured to receive an indication of a number of layers that are coupled between the first precoding group and the second precoding group.

12. The apparatus of claim 1, wherein a number of layers that are coupled between the first precoding group and the second precoding group include contiguous layers starting at a first layer index or an offset from the first layer that is predefined or indicated by a downlink control information.

13. The apparatus of claim 1, wherein the one or more processors, individually or in combination, are further configured to transmit an indication of support for spatial coupling across precoder groups.

14. The apparatus of claim 13, wherein the indication of support indicates one or more of a number of precoding groups for spatial coupling, a maximum number of layers in a precoding group, or a maximum number of coupling groups.

15. A method of receiving a code block, comprising:
receiving a first part of the code block on a first layer of a first precoding group;
receiving a second part of the code block on a second layer of a second precoding group, the second layer spatially coupled with the first layer of the first precoding group;
demapping the first part in a first demapper and demapping the second part in a second demapper; and
decoding the code block based on the first part and the second part.

16. The method of claim 15, wherein the first precoding group is associated with a first generalized geometric mean decomposition (GGMD) precoder and the second precoding group is associated with a second GGMD precoder.

17. The method of claim 15, further comprising:
re-encoding the decoded code block based on a first precoder associated with the first precoding group and a second precoder associated with the second precoding group;
reconstructing a signal based on the re-encoded block; and
cancelling the reconstructed signal from other layers in each of the first precoding group and the second precoding group.

18. The method of claim 15, wherein each layer in the first precoding group is mapped to a separate code block with a single codeword and a corresponding layer in the second precoding group is mapped to the single codeword or mapped to a different codeword of the code block and each codeword is mapped to a corresponding layer in the second precoding group, each codeword of the code block having a same modulation and coding scheme.

19. The method of claim 15, wherein the second part of the code block on the second layer in the second precoding group is offset in time, frequency, or both from the first part of the code block on the first layer in the first precoding group.

20. An apparatus for receiving a code block, comprising:
means for receiving a first part of the code block on a first layer of a first precoding group and receiving a second part of the code block on a second layer of a second precoding group, the second layer spatially coupled with the first layer of the first precoding group;
means for demapping the first part in a first demapper and demapping the second part in a second demapper; and
means for decoding the code block based on the first part and the second part.
